(19) United States
(12) Patent Application Publication
(10) Pub. No.: US 2007/0194070 A1
(43) Pub. Date: Aug. 23, 2007

(54) Snowboard carrier

(76) Inventor: Michael L. Rash, Oroville, CA (US)

Correspondence Address: Raymond M. Galasso, Galasso & Associates LP, P.O. Box 26503, Austin, TX, 78755-0503, US

(21) Appl. No.: 11/359,038

(22) Filed: Feb. 21, 2006

(51) Int. Cl. B60R 9/00; B60R 11/00

(52) U.S. Cl. 224/519; 224/917.5; 224/525

(57) ABSTRACT

A snowboard carrier designed to be attached to a standard frame hitch receiver of an automobile for transporting a plurality of snowboards. The snowboard carrier includes a shank having two ends, configured to be releasably secured to a frame hitch receiver. Pivotally mounted thereon the shank opposite the frame hitch receiver is a support beam. The support beam has a pair of parallel lateral support members distally located from each other. The lateral support members have a plurality of board support members that define board slots which are configured to receive a snowboard therein. A locking beam is releasably secured superimposed the lateral support members and board slots.

### FIELD OF THE INVENTION

The present invention relates a snowboard carrier, more specifically but not by way of limitation, a snowboard carrier that is designed to transport multiple snowboards that is releasably secured onto a standard frame hitch receiver of an automobile.

### BACKGROUND

Snow sports are enjoyed by thousands of individuals each year. The number of participants in the sport of snowboarding has been extremely prolific over the last decade. Each season, snowboarders journey to their favorite area to enjoy the sport.

Snowboarders typically require boots, snowsuits and snowboards at a minimum to participate in the sport. This equipment is bulky and typically consumes a significant portion of the interior of an automobile which leaves little room for passengers. This also presents a safety hazard having the large boards transported unsecured in the passenger compartment of an automobile. Standard snowboards are usually at least four feet in length which can be difficult to store in trunks of many automobiles. This length often present challenges when trying to transport one or more snowboards inside the passenger compartment of a vehicle.

Another problem exists during transporting of snowboards. Snowboards are quite expensive and have edges that must be properly maintained. Without proper storage during transportation, the edges of snowboards can be easily damaged.

Accordingly, there is a need for a device that can transport at least one snowboard externally located on the vehicle to eliminate the need to transport the snowboard within the passenger compartment or trunk of the automobile.

### SUMMARY OF THE INVENTION

It is the object of the present invention to provide a device that can transport at least one snowboard that is releasably secured to the exterior of an automobile.

It is another object of the present invention to provide a device that can transport at least one snowboard that is releasably secured to a standard frame hitch receiver of an automobile.

It is a further object of the present invention to provide a device that can transport at least one snowboard that is non-corrosive and weather-proof.

Yet another object of the present invention is to provide a device that can transport at least one snowboard that will not cause any damage to the snowboards placed thereon.

Another object of the present invention is to provide a device that can transport at least one snowboard that is releasably secured to the exterior of an automobile that is inexpensive and easy to use.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an embodiment of the present invention in a first position;

FIG. 2 is a side view of an embodiment of the present invention in a second position;

FIG. 3 is an end view of an embodiment of the present invention;

FIG. 4 is a rear view of an embodiment of the present invention in its second position;

FIG. 5 is enlarged partial perspective view of an embodiment of the present invention;

FIG. 6 is a perspective view of an embodiemnt of the present invention in the second position.

### DETAILED DESCRIPTION

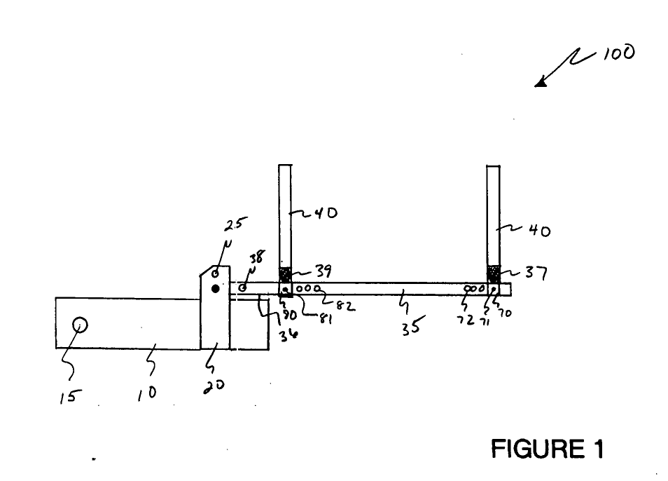

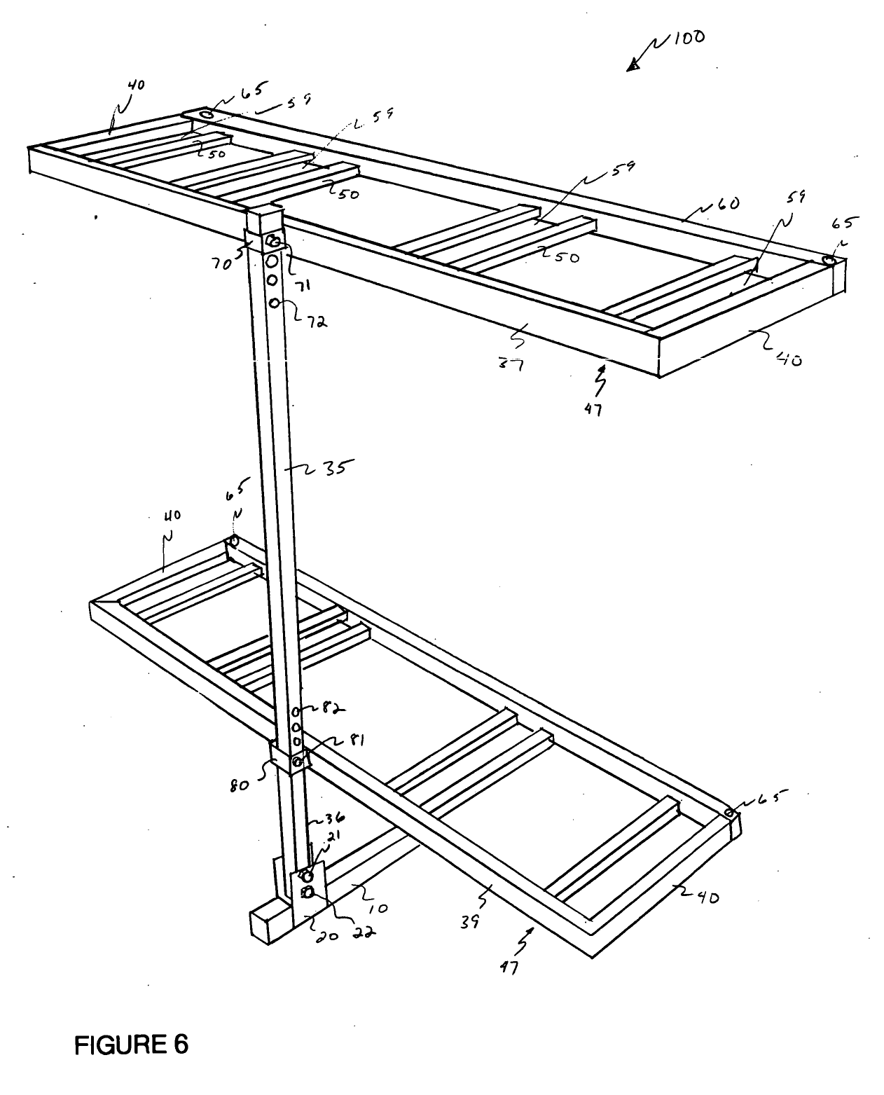

Referring now to FIGS. 1-6, wherein the various elements depicted therein are not necessarily drawn to scale, and wherein like elements are designated with identical reference numerals throughout the views and figures, there is illustrated a snowboard carrier 100 constructed according to the principles of the present invention.

The snowboard carrier 100 comprises a shank 10. The shank 10 is manufactured from square steel tubing and has an appropriate diameter to mateably connect with a standard frame hitch receiver on an automobile. Although no specific diameter is required good results have been achieved with a shank 10 having a diameter of two inches. The shank 10 is inserted into a receiver of a standard frame hitch and functions to releasably connect the snowboard carrier 100 to a vehicle that has mounted thereon a standard frame hitch receiver. Furthermore, while no specific length is required, good results have been achieved with a shank 10 that is two feet in length. Located proximate the first end of the shank 10 is the shank aperture 15. The shank aperture 15 will align with an aperture on a conventional frame hitch receiver and allow a standard mechanical pin to be journaled through the shank aperture 15 and the aligned aperture of the frame hitch receiver thereby releasably securing the snowboard carrier 100 to the conventional frame hitch receiver of a vehicle. Those skilled in the art should recognize that the shank 10 could be manufactured from numerous different types of metals or other suitable rigid material such as but not limited to steel or aluminum.

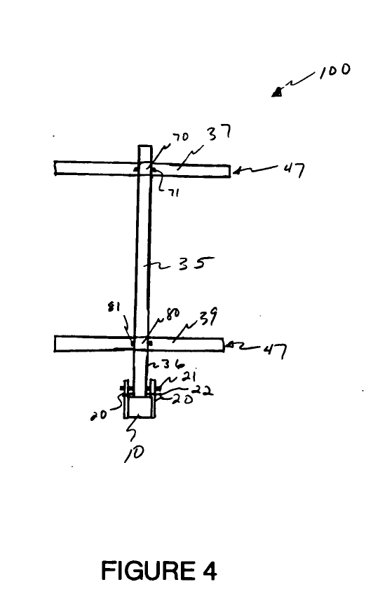

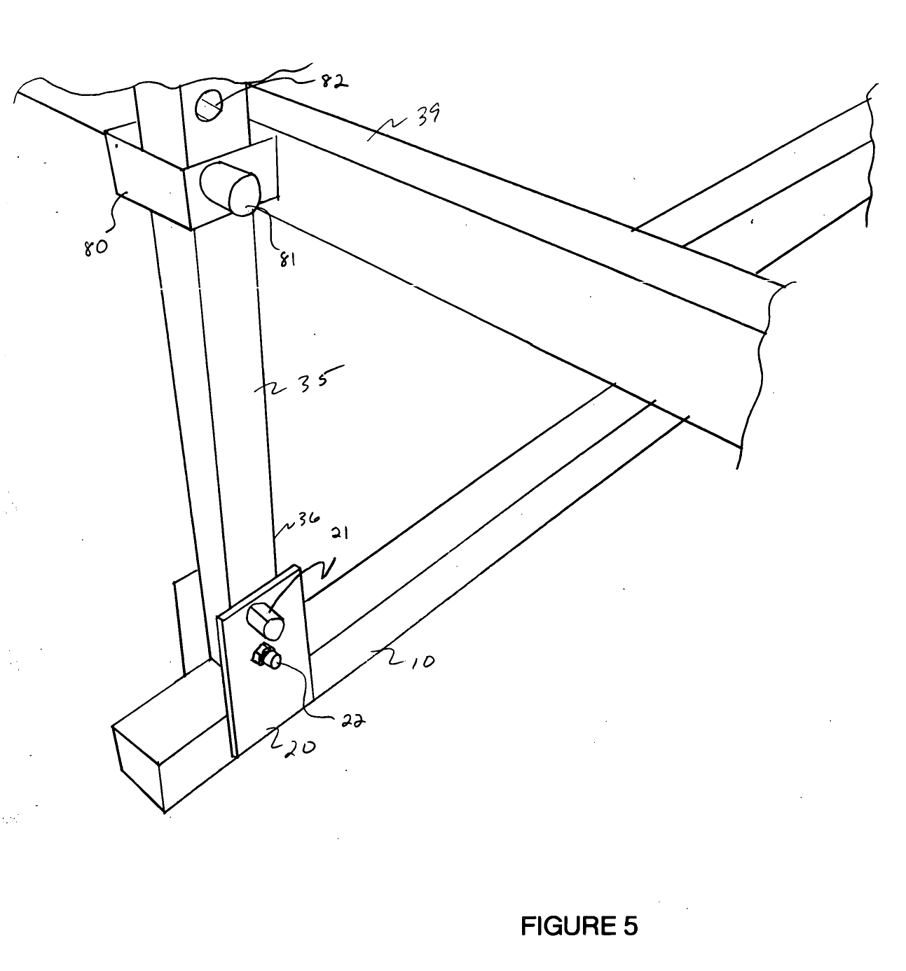

Distally located on the shank 10 from the shank aperture 15 are two mounting plates 20 (see FIGS. 4 and 5). The mounting plates 20 are fastened to the shank 10 by conventional methods such as but not limited to welding. Extending upward from the shank 10, the mounting plates 20 are mounted on opposing sides of the shank 10. The mounting plates 20 are generally parallel with each other. A nut and bolt 22 combination is utilized to pivotally and removably secure support beam 35 to mounting plates 20. Centrally located on the mounting plate 20 distal to the shank 10 is a mounting plate aperture 25. The mounting plate aperture 25 is configured to receive therein a standard pin 21 thereby releasably securing the support beam 35 in its second position. Although no specific dimension is required for the mounting plates 20, good results have been achieved with a mounting plates 20 that are approximately six inches in height by six inches in width being generally three-sixteenths of an inch in thickness. Those skilled in the art should recognize that numerous different shapes and sizes of the mounting plate 20 could be utilized to achieve the desired function as described herein.

Pivotally mounted to the mounting plates 20 with nut and bolt 22 and superposed to the shank 10 is a support beam 35. The support beam 35 is manufactured from conventional square steel tubing. The support beam 35 has a first end 36 that is pivotally mounted intermediate the mounting plates 20. The support beam 35 pivots to a substantially horizontal position permitting a user to place objects thereon to be transported. Proximate the first end 36 of the support beam 35 is a support beam aperture 38. The support beam aperture 38 completely penetrates the support beam 35 and is configured to receive therein standard pin 21. In its second position, the support beam 35 is releasably secured into a substantially vertical position whereby the support beam aperture 38 and the mounting plate aperture 25 are aligned and a pin is journaled therethrough. The snowboard carrier 100 is transported when the support beam 35 is in its second position. Although no specific steel tubing is required for the support beam 35, good results have been achieved utilizing steel tubing that is approximately one and a half inches in diameter.

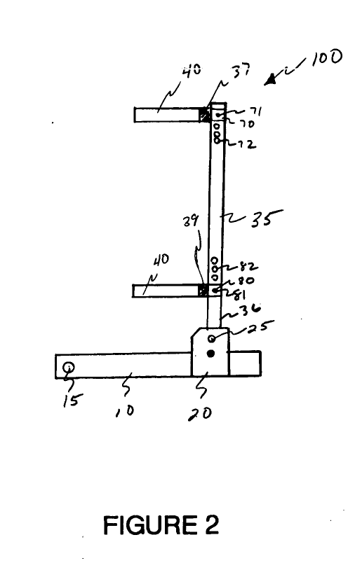

Superposed to the support beam 35 and extending outwardly therefrom are two later support members 47, including an upper lateral support member 37 and a lower lateral support member 39 (see FIGS. 2-4 and 6). The upper lateral support member 37 is removable fastened proximate to the second end of the support beam 35 with a sleeve 70 and a standard pin 71 extending through holes in both sleeve 70 and beam 35. As illustrated, beam 35 is configured with additional holes 72 to facilitate the adjustment of the position of upper lateral support member 37 on beam 35. The upper lateral support member 37 is manufactured from square steel tubing. Although no specific size of square steel tubing is required, good results have been achieved with steel tubing that is approximately one and half inches in diameter. Those skilled in the art should recognize that numerous different shapes of steel tubing could be utilized to achieve the function as described herein.

Mounted parallel with respect to the upper lateral support member 37 is a lower lateral support member 39. The lower lateral support member 39 is removable fastened proximate to the first end of the support beam 35 with a sleeve 80 and a standard pin 81 extending through holes in both sleeve 80 and beam 35. As illustrated, beam 35 is configured with additional holes 82 to facilitate the adjustment of the position of lower lateral support member 39 on beam 35. The lower lateral support member 39 is manufactured from square steel tubing. Although no specific size of square steel tubing is required, good results have been achieved with steel tubing that is approximately one and half inches in diameter. Those skilled in the art should recognize that numerous different shapes of steel tubing could be utilized to achieve the function as described herein. The lateral support members 47 function to support objects placed on the snowboard carrier 100. As illlustrated the distance between lateral support members 47 can be varied to accommodate various sized snowboards.

Integrally mounted with the lower lateral support member 39 and the upper lateral support member 37 and generally perpendicular thereto are four end support members 40. The end support members 40 are secured by conventional methods such as but not limited to welding and are fastened on each end of the upper lateral support member 37 and lower lateral support member 39. The end support members 40 function to provide support for objects placed thereon the snowboard carrier and define the lateral edges of the frame area 51 of the snowboard carrier 100. The end support members 40 are hollow so as to permit receipt of the locking beam end support members 63 therein. Journaled through each end of the end support members 40 distal to the lateral support members 47 are end support member apertures 45. The end support member apertures 45 are configured to receive therein a pin or conventional padlock shank. Although no specific length is required for the end support members 40, good results have been achieved with the end support members 40 approximately fifteen and a half inches in length.

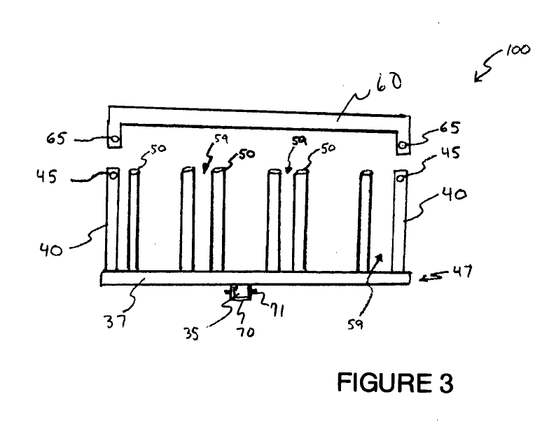

Now referring in particular to FIG. 3, superposed each lateral support member 47 is a locking beam 60. The locking beam is manufactured from square steel tubing. Contiguously mounted on each end of the locking beam 60 and perpendicular thereto is a pair of locking beam end support members 63. The locking beam end support members 63 are of appropriate diameter to mateably connect with each end support member 40. Journaled through each locking beam end support member 63 distal to the locking beam 60 is a locking beam aperture 65. Upon engagement with the end support members 40 the locking beam aperture 65 and the end support member aperture 45 are aligned in order to facilitate the securing of the locking beam 60 to the end support members 40 by a conventional pin or other locking mechanism such as but not limited to a padlock. Those skilled in the art should further recognize that different amounts of locking beams 60 could be utilized.

Mounted along each lateral support member 47 interposed each end support member 40 are a plurality of board support members 50. The board support members 50 upwardly extend from the lateral support members 47 and are secured by conventional methods such as but not limited to welding. The board support members 50 are mounted to the lateral support members 47 in pairs and are generally mounted adjacent to each other defining a board slot 59 interposed each pair of board support members 50. The board slots 59 are configured to receive therein an object of relatively low thickness such as but not limited to a snowboard. A single board support member 50 is secured adjacent to each end support member 40 that further defines another board slot 59. The board support members 50 are manufactured from metal tubing such as but not limited to steel or aluminum. Although no specific dimension is required for the board support members 50, good results have been achieved with a board support member 50 that is seven-eighths of an inch diameter. While in the drawings submitted herewith, the board support members 50 are illustrated as steel tubes, it is contemplated within the scope of the present invention that the board support members 50 could be covered with a protective coating to prevent damage to objects placed therebetween. Furthermore it is contemplated within the scope of the present invention that the lateral support members 47 and end support members 40 could be coated with a protective coating to prevent damage to any object placed adjacent thereto. Although no specific amount of board slots 59 are required, good results have been achieved with a snowboard carrier 100 having four board slots 59.

A description of the operation of the snowboard carrier 100 is as follows. In use, the user will insert the shank 10 into the receiver of a standard frame hitch that is located on a vehicle and secure into position with a standard mechanical pin 21 such as but not limited to a clevis pin. The user will place the support beam 35 in its first position whereby the support beam 35 is configured in a substantially horizontal manner. The spacing of lateral support members 47 will be adjusted to accommodate the size of the snowboards to be transported. Subsequent to positioning the support beam 35 the board support members 50 and end support members 40 are generally extending upward. The user will then placed the desired objects to be transported such as but not limited to snowboards in the board slots 59 intermediate the board support members 50. Ensuing to placing the desired objects in the board slots 59, the user then places the locking beam 60 into position whereby the locking beam end support members 63 are mateably connected with the end support members 40. The locking beam aperture 65 and the end support member aperture 45 are aligned permitting the user to journal through the apertures a locking pin or shank of a conventional padlock. The user then places the support beam 35 into its second position wherein the support beam is perpendicular with the shank 10. The support beam 35 is secured into its second position whereby the user will journal a pin or other suitable locking device through the mounting plate aperture 25 and the corresponding support beam aperture 38.

In the preceding detailed description, reference has been made to the accompanying drawings that form part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An apparatus for transporting snowboards comprising:
a shank configured to mate with a vehicle hitch receiver;
a support beam pivotally connected to said shank, said support beam having a first end portion and a second end portion;
a first support member connected to said first end portion of said support beam;
a second support member connected to said second end portion of said support beam; and
said first support member and said second support member configured to receive a snowboard for transportation.

2. The apparatus as recited in claim 1, and further including a plurality of end supports with at least a first pair of said plurality of end supports connected to said first support member and a second pair of said plurality of end support members connected to said second support member.

3. The apparatus as recited in claim 2, and further comprising a plurality of board support members, with at least one board support member positioned intermediate said first pair of plurality of end supports and at least one board support member positioned intermediate said second pair of plurality of end supports, said plurality of board support members configured to receive therein a snowboard.

4. The apparatus as recited in claim 3, and further comprising at least one locking beam, said at least one locking beam configured to connected to said first pair of plurality of end supports.

5. The apparatus as recited in claim 4, wherein said shank includes at least one mounting plate with said support beam pivotally connected to said at least one mounting plate.

6. The apparatus as recited in claim 5, wherein said at least locking beam configured to receive a locking pin to secure said at least one locking beam to said first pair of plurality of end supports.

7. The apparatus as recited in claim 6, wherein said support beam is movable between at least a first position and a second position, such that when said support beam is in said first position said support beam is generally parallel to said shank, and where said support beam is in said second position, said support beam is generally perpendicular to said shank.

8. A snowboard carrier configured to connect to a frame hitch receiver of an vehicle, comprising:
an upper and lower lateral support member, said upper lateral support member and said lower lateral support member configured generally being parallel with each other, each of said upper and lower lateral support members having a first and second end;
a support beam, said support beam having a first and second end, said upper and lower support members removabley connected to said support beam, said second end of said support beam being proximate to said upper lateral support member, said first end of said support beam being proximate said lower lateral support member, said support beam being generally perpendicular to said upper and lower lateral support members;
a shank, said shank having a first and second end, said first end of said shank being configured to connect with the frame hitch receiver, said second end of said shank being proximate said first end of said support beam; and
two mounting plates, said mounting plates being proximate said second end of said shank, said mounting plates extending upward from said shank, said mounting plates configured to pivotally receive therein said first end of said support beam.

9. The snowboard carrier as recited in claim 9, and further comprising four end support members, with a first and second of said end support members being connected to said upper lateral support member and with a third and a fourth of said end support members connected to said lower lateral support members.

10. The snowboard carrier as recited in claim 9, and further comprising a first and second locking beam, with said first locking beam connectable to said first and second end support members and said second locking beam connectable to said third and fourth end support members.

11. The snowboard carrier as recited in claim 10, and further comprising a first plurality of board support members positioned intermediate said first end support member and said second end support member, and further comprising a second plurality of board support members positioned intermediate said third end support member and said fourth end support member, with each of said first plurality of board support members and said second plurality of board support members configured to receive at least one snowboard.

12. The snowboard carrier as recited in claim 11, wherein said first end of said support beam includes an aperture journaled therethrough.

13. The snowboard carrier as recited in claim 12, wherein said mounting plates further contain a hole centrally located distal to said shank, said hole for aligning with said aperture of said support beam upon said beam being engaged in its second position.

14. The snowboard carrier as recited in claim 13, wherein said support beam has a first and second position, in said first position said support beam is configured in a substantially horizontal manner, in said second position said support beam is releasbaly secured in a substantially vertical manner with said hole on said mounting plate and said aperture on said support beam being aligned to allow a locking pin to be received therein.

15. A snowboard carrier configured to be mateably connected to a conventional frame hitch receiver of an automobile comprising:
an upper and lower lateral support member, said lateral support members generally being parallel with each other, said upper and lower lateral support members having a first and second end;
a support beam, said support beam having a first and second end, said support beam connected between said upper and lower lateral support members, said second end of said support beam being proximate to said upper lateral support member, said first end of said support beam being proximate said lower lateral support member, said support beam being perpendicular to said lateral support members;
a shank, said shank having a first and second end, said first end of said shank being configured to mateably connect with a automobile frame hitch receiver, said second end of said shank being proximate and underneath said first end of said support beam.
two mounting plates, said mounting plates being proximate said second end of said shank, said mounting plates extending upward from said shank and further being secured on opposing sides of said shank, said mounting plates configured to receive therein said first end of said support beam;
four end support members, said end support members having a first end and a second end, said first end of said end support members being integrally mounted to each end of said upper and lower lateral support members and being perpendicular thereto, said second end of said end support members having an opening configured to receive a square tube therein, said end support members further having an aperture proximate said second end;
two locking beams, said locking beams being superposed said end support members and generally parallel with said upper and lower lateral support members, said locking beams being mateably connected to said openings of said end support members;
a plurality of board support members, said board support members being mounted interposed said end support members on said upper and lower lateral support members, said board support members being perpendicular with said upper and lower lateral support members, said board support members further defining a plurality of board slots configured to receive therein a snowboard.

16. The snowboard carrier as recited in claim 15, wherein said snowboard carrier has four board slots.

17. The snowboard carrier as recited in claim 16, wherein said shank is manufactured from two inch square tubing and is approximately two feet in length.

18. The snowboard carrier as recited in claim 17, wherein said support beam is manufactured from one and a half square inch tubing and is approximately four feet in length.

19. The snowboard carrier as recited in claim 18, wherein said board support members are manufactured from pipe that is approximately seven-eighths inches in diameter.

20. The snowboard carrier as recited in claim 19, wherein said snowboard carrier is manufactured from a group of material consisting of steel or aluminum.
